(19) United States
(12) Patent Application Publication
(10) Pub. No.: US 2005/0008542 A1
(43) Pub. Date: Jan. 13, 2005

(54) Air mixing chamber

(76) Inventor: Minken Patrick Yeh, Sandy, UT (US)

Correspondence Address: Kirton & McConkie, 1800 Eagle Gate Tower, 60 East South Temple, Salt Lake City, UT, 84111, US

(21) Appl. No.: 10/614,463

(22) Filed: Jul. 7, 2003

(51) Int. Cl. B01L 3/00

(52) U.S. Cl. 422/99

(57) ABSTRACT

An air mixing chamber is herein provided. More particularly, the air mixing chamber mixes the end-tidal and dead space air of exhaled breath for purposes of analysis using baffles with holes that direct the flow of the exhaled breath. The baffles are enclosed inside an enclosure that includes an inlet tube, an outlet tube and a sensor.

### BACKGROUND OF THE INVENTION

1. Field of the Invention

The present invention relates to mixing air for purposes of analysis. More particularly, the present invention relates to mixing the end-tidal and dead space air of exhaled breath.

2. Background and Related Art

Analysis of a person's breath is often used in metabolic measurement to facilitate medical or scientific testing and can be helpful in detecting diseases, the presence of alcohol and drugs and in testing other health-related factors such as stress.

Exhaled air is especially useful for analysis purposes because of the oxygen-carbon dioxide exchange with the pulmonary capillary blood. This exchange allows for meaningful analysis. Unfortunately, not all exhaled air has gone through such an exchange. Some portions of the exhaled air consist merely of dead space air that has not interacted with the body and is consequently, not useful for analysis purposes. An end-tidal sample is most useful because it typically consists only of alveolar air (air where the oxygen-carbon dioxide exchange with the pulmonary capillary blood has occurred), whereas the initial air expired usually consists only of dead space air. When exhaled air is analyzed, the results are often skewed because the results of the end-tidal and dead space air samples differ.

To solve this problem, mixing chambers exist to mix the end-tidal and dead space air samples together before analysis. Some mixing chambers use baffles placed vertically inside the chamber with holes to facilitate mixing. Other mixing chambers use baffles placed vertically inside the chamber with rectangle side openings for air to flow through. Other mixing chambers consist of at least one cylinder within another where the inside cylinder has holes through which some of the exhaled air travels. Although these mixing chambers have improved the mixing of the end-tidal and dead air space, the dead air still travels through the mixing chamber with a significant portion unmixed.

### SUMMARY OF THE INVENTION

The present invention relates to mixing air for purposes of analysis. More particularly, the present invention relates to mixing the end-tidal and dead space air of exhaled breath.

The preferred embodiment of the present invention involves an air mixing chamber configured to mix the end-tidal and dead space air of exhaled breath. The air mixing chamber receives exhaled breath through an inlet tube, mixes the exhaled breath by using baffles, samples the mixed exhaled breath using a sensor and finally expels it. The baffles are configured in such a way to maximize the effectiveness of the mixing. The first baffle is angled toward the inlet, bifurcating the main flow of air as some travels over the tapered upper section of the baffle and some downward. As the air travels downward, some escapes through the holes of the baffle while some travels to the base of the air mixing chamber. Because the sides and base of the baffle are continuously connected to the walls of the air mixing chamber, the air is then forced to travel back up the baffle until it either travels through the holes of the baffle or exits above the tapered upper section of the baffle. As the bifurcated flow of air reunites, chaos and additional mixing is caused by the various directions the air enters the opposite side of the baffle as the downward traveling air that has passed over the tapered upper section of the baffle meets the portion of the stream of air that has passed through the holes in the baffle.

The next baffle further facilitates mixing because it is angled at an opposite direction of the first baffle and because the tapered section of the baffle faces downward. As a result, the bifurcated flow of air coming over the first baffle is forced downward where, as discussed above, it meets the air that is rising after having traveled through the holes in the first baffle. This causes chaos and more mixing as the air makes its way downward and either through the holes of the second baffle or under the tapered section of the second baffle and finally reaches the opposite side of the second baffle. Additional baffles are similarly configured to cause chaos and successfully mix the air until it is expelled.

The tapered sections of the baffles facilitate the shifting in the direction of the air. The holes in the baffles decrease the back pressure felt by the person exhaling into the air mixing chamber, allowing him or her to exhale into the air mixing chamber without the air bouncing out.

Another embodiment of the present invention has baffles that are perpendicular to the base of the air mixing chamber.

In yet another embodiment, the air mixing chamber consists of only one baffle.

In even another embodiment, the air mixing chamber does not have a sensor.

Another embodiment of the present invention has baffles that are essentially rectangle.

While the methods and processes of the present invention have proven to be particularly useful in the area of exhaled breath mixing, those skilled in the art can appreciate that the methods and processes can be used in a variety of different applications and in a variety of different areas of manufacture to mix other types of air or fluid.

These and other features and advantages of the present invention will be set forth or will become more fully apparent in the description that follows and in the appended claims. The features and advantages may be realized and obtained by means of the instruments..and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a transparent cross section of an air mixing chamber.

FIG. 2 illustrates a baffle.

### DETAILED DESCRIPTION OF THE INVENTION

The present invention relates to mixing air for purposes of analysis. More particularly, the present invention relates to mixing the end-tidal and dead space air of exhaled breath.

In the disclosure and in the claims the term “air” shall refer to any gas capable of mixing. Examples of air include the exhaled breath of a human or an animal, and the mixture of invisible odorless tasteless gases, such as nitrogen and oxygen, which surrounds the earth.

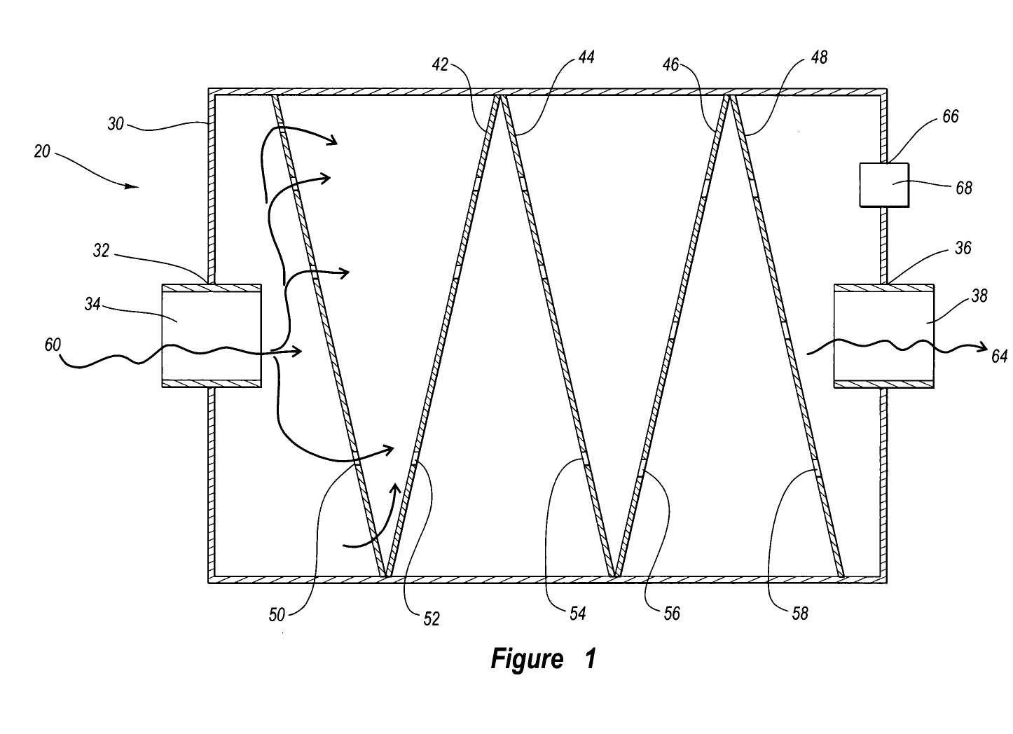

FIG. 1 illustrates a transparent cross section of an air mixing chamber 20 that includes an enclosure 30, an inlet opening 32, an inlet tube 34, an outlet opening 36, an outlet tube 38, a first baffle 40, a second baffle 42, a third baffle 44, a fourth baffle 46, a fifth baffle 48, a first baffle set of holes 50, a second baffle set of holes 52, a third baffle set of holes 54, a fourth baffle set of holes 56, a fifth baffle set of holes 58, an unmixed stream of air 60, a stream of air in the process of mixing 62, a mixed stream of air 64, an opening formed in the enclosure near said outlet tube 66 and a sensor 68.

Unmixed stream of air 60 enters air mixing chamber 20 through inlet tube 34. First baffle 40 is angled toward inlet opening 32 and directs unmixed stream of air 60 through first baffle set of holes 50 or over first baffle 40. Stream of air in the process of mixing 62 is then directed by second baffle 42 through second baffle set of holes 52 or under second baffle 42. Stream of air in the process of mixing 62 then continues its path, passing either through third baffle set of holes 54 or over third baffle 44, through fourth baffle set of holes 56 or under fourth baffle 46, and finally, through fifth baffle set of holes 58 or over fifth baffle 48. Mixed stream of air 64 is then sampled by sensor 68 following which mixed stream of air 64 exits air mixing chamber 20 through outlet tube 38.

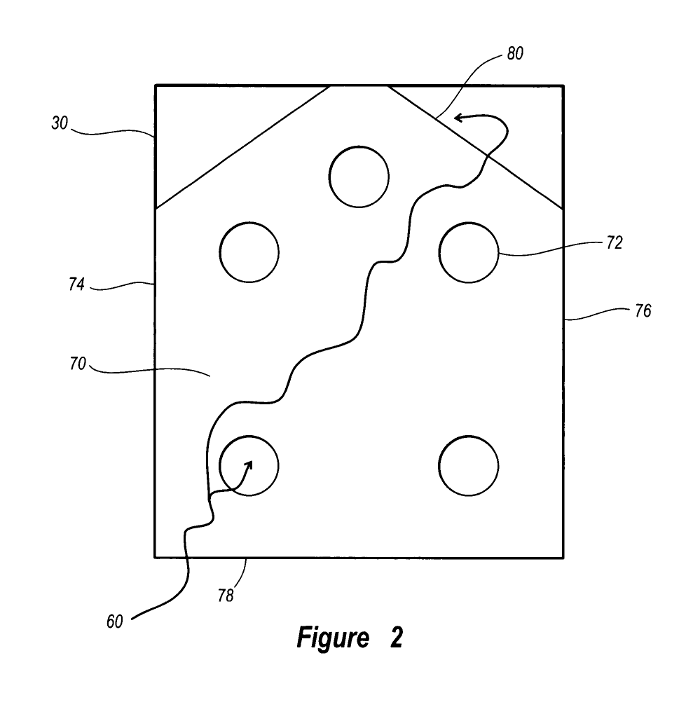

FIG. 2 illustrates a tapered baffle 70 with a set of holes 72 enclosed inside enclosure 30. In the illustrated embodiment, a first side of tapered baffle 74, a second side of tapered baffle 76 and a base of tapered baffle 78 are continuously connected to enclosure 30. This continuous connection forces unmixed stream of air 60 to pass either through set of holes 72 or over tapered section of tapered baffle 80.

Thus, as discussed herein, the embodiments of the present invention embrace an air mixing chamber. In particular, the present invention relates to mixing the end-tidal and dead space air of exhaled breath. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An air mixing chamber comprising:
an enclosure;
an inlet opening formed in said enclosure to form an inlet;
an inlet tube set in said inlet opening;
an outlet opening formed in said enclosure to form an outlet;
an outlet tube set in said outlet opening;
a baffle enclosed inside said enclosure for directing the flow of a stream of air introduced through said inlet tube, said baffle having a section which is tapered to bifurcate the stream of air passing over said baffle and wherein said baffle is angled toward said inlet so that said stream of air is partially reversed before it passes over said baffle and wherein said baffle has a hole placed therein to allow passage of a portion of said stream of air there through, thereby allowing interaction and agitation between said bifurcated flow of air coming over the top of said baffle and said portion of the stream of air passing through said hole in said baffle;
an opening formed in the enclosure near said outlet tube; and
a sensor set in said opening to allow sampling of the now thoroughly mixed stream of air.

2. An air mixing chamber as recited in claim 1, wherein said hole comprises multiple holes.

3. An air mixing chamber as recited in claim 1, wherein said baffle comprises multiple baffles.

4. An air mixing chamber as recited in claim 1, wherein said baffle is substantially triangular.

5. An air mixing chamber as recited in claim 1, wherein at least three sides of said baffle are continuously connected to said enclosure.

6. An air mixing chamber as recited in claim 1, wherein said baffle is essentially rectangular.

7. A method for mixing a stream of exhaled air, said method comprising the steps of:
providing a mixing chamber that houses tapered, angled baffles with holes;
exhaling into said mixing chamber;
causing a stream of dead space air to mix with a stream of end-tidal air while inside said mixing chamber by redirecting the flow of said stream of exhaled air; and
causing said stream of exhaled air to exit said chamber.

8. A method as recited in claim 7, further comprising the step of sampling said stream of exhaled air after mixing but before exiting said chamber.

9. An air mixing chamber comprising:
an enclosure;
an inlet opening formed in said enclosure to form an inlet;
an inlet tube set in said inlet opening;
an outlet opening formed in said enclosure to form an outlet;
an outlet tube set in said outlet opening; and
a baffle enclosed inside said enclosure for directing the flow of a stream of air introduced through said inlet tube, said baffle having a section which is tapered to bifurcate the stream of air passing over said baffle and wherein said baffle is angled toward said inlet so that said stream of air is partially reversed before it passes over said baffle and wherein said baffle has a hole placed therein to allow passage of a portion of said stream of air there through, thereby allowing interaction and agitation between said bifurcated flow of air coming over the top of said baffle and said portion of the stream of air passing through said hole in said baffle.

10. An air mixing chamber as recited in claim 9, wherein said hole comprises multiple holes.

11. An air mixing chamber as recited in claim 9, wherein said baffle comprises multiple baffles.

12. An air mixing chamber as recited in claim 9, wherein said baffle is substantially triangular.

13. An air mixing chamber as recited in claim 9, wherein at least three sides of said baffle are continuously connected to said enclosure.

14. An air mixing chamber comprising:
an enclosure;
an inlet opening formed in said enclosure to form an inlet;
an inlet tube set in said inlet opening;
an outlet opening formed in said enclosure to form an outlet;
an outlet tube set in said outlet opening;
a baffle enclosed inside said enclosure for directing the flow of a stream of air introduced through said inlet tube, said baffle having a section which is tapered to bifurcate the stream of air passing over said baffle and wherein said baffle has a hole placed therein to allow passage of a portion of said stream of air there through, thereby allowing interaction and agitation between said bifurcated flow of air coming over the top of said baffle and said portion of the stream of air passing through said hole in said baffle;
an opening formed in the enclosure near said outlet tube; and
a sensor set in said opening to allow sampling of the now thoroughly mixed stream of air.

15. An air mixing chamber as recited in claim 14, wherein said hole comprises multiple holes.

16. An air mixing chamber as recited in claim 14, wherein said baffle comprises multiple baffles.

17. An air mixing chamber as recited in claim 14, wherein said baffle is substantially triangular.

18. An air mixing chamber as recited in claim 14, wherein at least three sides of said baffle are continuously connected to said enclosure.

19. An air mixing chamber comprising:
an enclosure;
an inlet opening formed in said enclosure to form an inlet;
an inlet tube set in said inlet opening;
an outlet opening formed in said enclosure to form an outlet;
an outlet tube set in said outlet opening;
a baffle enclosed inside said enclosure for directing the flow of a stream of air introduced through said inlet tube, wherein said baffle is essentially rectangle and wherein said baffle has a hole placed therein to allow passage of a portion of said stream of air there through;
an opening formed in the enclosure near said outlet tube; and
a sensor set in said opening to allow sampling of the now thoroughly mixed stream of air.

20. An air mixing chamber as recited in claim 19, wherein said hole comprises multiple holes and wherein said baffle comprises multiple baffles.
